(19) United States
(12) Patent Application Publication
(10) Pub. No.: US 2012/0054958 A1
(43) Pub. Date: Mar. 8, 2012

(54) RECLINER SEAT APPARATUS

(75) Inventors: William E. Stimel, Alexandria, OH (US); Keith A. Overton, Columbus, OH (US)

(73) Assignee: CVG MANAGEMENT CORPORATION, New Albany, OH (US)

(21) Appl. No.: 13/223,975

(22) Filed: Sep. 1, 2011

Related U.S. Application Data
(60) Provisional application No. 61/379,941, filed on Sep. 3, 2010.

(51) Int. Cl. A47B 83/02; B60N 2/20; A47B 83/00; A47C 7/50; A47C 7/74; B60N 2/22; B60N 2/44

(52) U.S. Cl. 5/2.1; 297/135

(57) ABSTRACT

A recliner assembly that can be deployed within a cab of a truck is disclosed. The recliner assembly includes a seat apparatus having a rear portion recliner mechanism. Additionally, the recliner assembly includes a drop down table/support assembly that enables a lounge-like position. Further, a complementary seat/footrest apparatus can be employed to enhance the recliner/bed position when deployed.

### CROSS-REFERENCE TO RELATED APPLICATIONS

This application claims the benefit of U.S. Provisional Patent Application Ser. No. 61/379,941 entitled “RECLINER SEAT APPARATUS” and filed on Sep. 3, 2010.

### BACKGROUND

The “cab” of a truck is an enclosed space where the operator (or driver) is seated. Today, long-haul truck cabs often include many amenities that enhance comfort of a driver. These amenities include air conditioning, ergonomic seats and controls, hi-fi sound and entertainment packages, etc.

The rearward portion of some cabs often includes a sleeper compartment equipped with amenities and services which include televisions, internet, beds and the like. A sleeper is often a separate compartment attached to the cab where the driver can rest while not driving. In most instances, sleeper units can range from a simple bunk compartment to a spacious “apartment-on-wheels.”

Because space is most often very limited within the sleeper portion of a cab, many appliances and the like have been reduced in size to accommodate the small spaces. Similarly, furnishings are strategically designed to optimize the limited space available in a cab. There exists a need to continue to develop space-saving furnishings for inside a sleeper compartment of a cab.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a recliner or seat apparatus that can be deployed within a cab of a truck. The recliner is equipped with features, functions and benefits that assist in efficient use of the limited space within a sleeper compartment of a cab. In addition to a rear upper back portion recliner mechanism, the recliner assembly includes a drop down table assembly that enables a lounge-like position. Additionally, the recliner assembly can be equipped with a variety of comfort features, including but not limited to, heated cushions, air conditioned cushions, vibrating cushions, etc.

Still further, in aspects, the recliner can be deployed within a recessed housing having steps that enable ease of reach to elevated items. In one aspect, the steps can provide easy access to an upper bunk area in the sleeper compartment. Additionally, by design, the recliner can employ an isolated headrest section as well as an isolated footrest section. Both the headrest and footrest portions can be adjustable at the convenience of a user.

Yet other aspects can include motorized adjustments of most any position within the recliner. For example, the motorized adjustments can control seat height, bolster portion comfort, headrest and footrest adjustment, among others. A memory can be used to store position settings, e.g., by user, by time of day, etc.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example recliner seat apparatus in accordance with an aspect of the innovation.

FIG. 2 illustrates an example rearward sleeper compartment in accordance with aspects of the innovation.

FIG. 3 illustrates a complementary seat apparatus in accordance with aspects of the innovation.

FIG. 4 illustrates an example recliner assembly in accordance with aspects of the innovation.

FIG. 5 illustrates an example drop down table support in accordance with an aspect of the innovation.

FIG. 6 illustrates an alternate view of an example drop down table support in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

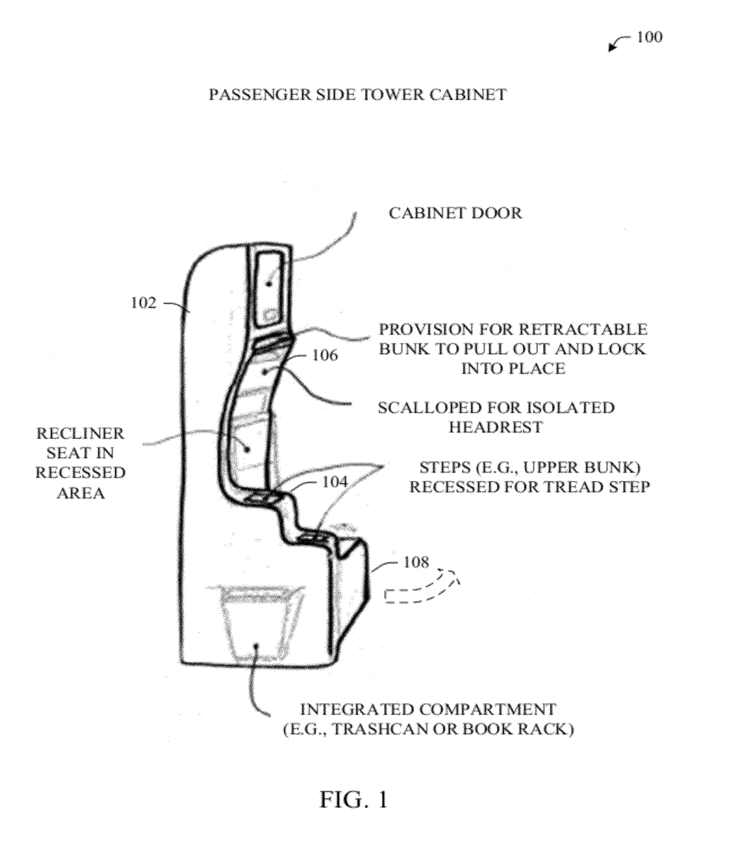

Referring initially to the drawings, FIG. 1 illustrates a side perspective view of a tower that includes a seat assembly 100 in accordance with aspects of the innovation. As shown, the tower assembly 100 can generally include a frame (e.g., cabinet or housing) 102, manufactured from most any suitably rigid material. For example, the frame 102 can be manufactured from wood, plastic, composite, metal, aluminum, alloys or the like. Additionally, it will be appreciated that most any recycled material can be employed to manufacture frame 102. Still further, if desired, the cabinet housing 102 can be padded and/or covered as desired (e.g., for aesthetic appeal).

The frame 102 can be molded or manufactured so as to include a step portion 104 that facilitates an individual to access elevated reach items and/or places. For example, the step portion 104 can assist an individual to reach a bunk or bed area of a cab. In other aspects, high reach area storage bins or the like can be accessed via the integrated step portion. As shown, the step portion or area 104 can include recesses that accommodate tread steps.

While a specific step area configuration is shown in FIG. 1, it is to be understood that most any configuration can be employed without departing from the spirit and/or scope of the features, functions and benefits described here. For instance, more or fewer steps can be employed in alternate embodiments—which are to be included within the scope of this disclosure.

In addition to the step portion 104, the frame 102 can be manufactured or molded to include storage bins, waste baskets, integrated cabinets, etc. by preference or design. It will be understood that most any custom feature can be integrated into the frame 102 as desired.

The tower seat assembly 100 can be equipped with most any cushions or comforts. In one aspect, an adjustable headrest 106 can be positioned into a scalloped area of the frame 102. Similarly, an adjustable footrest 108 can be incorporated into a lower portion of the frame 102 as illustrated in FIG. 1. The footrest 108 can be adjusted outward as shown by the dashed arrow in FIG. 1. It will be appreciated that most any hinging and/or pivoting mechanisms known in the art can be employed so as to effect the recline of seat or adjustment thereof.

Adjustment of the headrest 106, footrest 108 and other cushion areas of the seat assembly 100 can be manual or motorized in aspects. Additionally, a computerized memory can be employed that can retain seat settings for easy retrieval and adjustment. For instance, settings can be retained on a per user basis, a time of day (night versus morning) basis, etc. Further, it is to be understood that the seat portion can be adjustable based upon inclination, bolsters, lumbar support, bottom cushion location, stiffness, etc. These (and other) various adjustments are to be appreciated by those skilled in the art.

Still further, the headrest 106, footrest 108 and other cushion areas of the seat assembly 100 can be equipped with temperature adjustment and sensory features. For example, the areas can be equipped with air conditioned (e.g., perforated) materials, heated materials, as well as vibration and massaging sensory features.

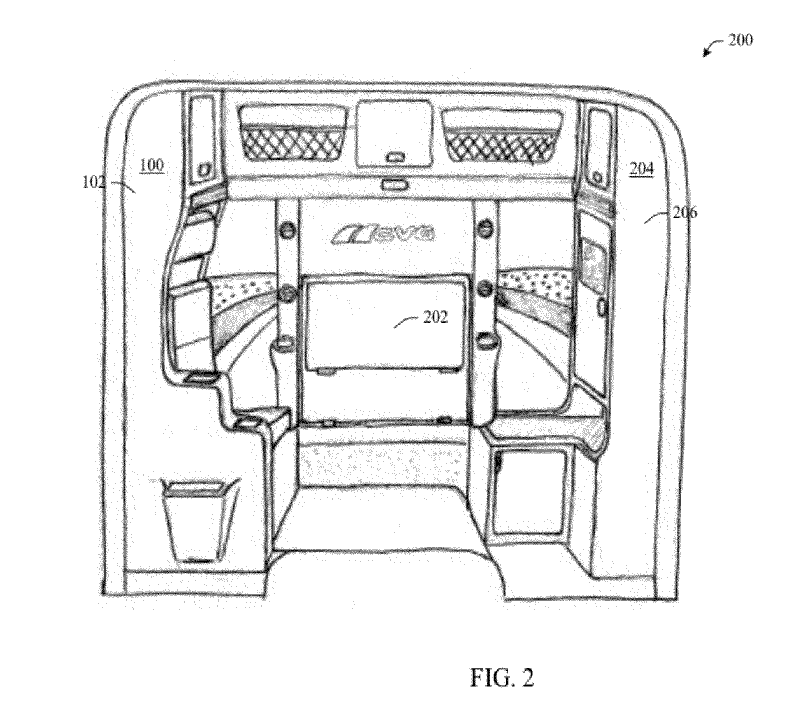

FIG. 2 illustrates an example rearward portion 200 of a truck cab in accordance with aspects of the innovation. As shown, the rearward portion 200 can include a tower recliner assembly 100 as shown in FIG. 1. Additionally, the cab section 200 can include a drop down table assembly 202 substantially centered within the cab area 200. As will be described in greater detail infra, the drop down table assembly 202 can horizontally fill a void between the recliner assembly 100 and a complementary tower assembly 204. It is to be appreciated that the drop down table 202 feature can be used in conjunction with a single tower apparatus as desired.

Similar to recliner portion 100, complementary tower assembly 204 can include a frame portion 206 manufactured in a similar manner as seating assembly 100 described supra. In use, the table 202 can be folded (e.g., hinged or pivoted) or positioned in an open or horizontal manner such that the void is filled. An individual can be seated upon the recliner 100, extend his/her legs across the table 200 and onto the complementary tower assembly 204. Similar to seat assembly 100, tower assembly 204 can be equipped with comfort access features as desired.

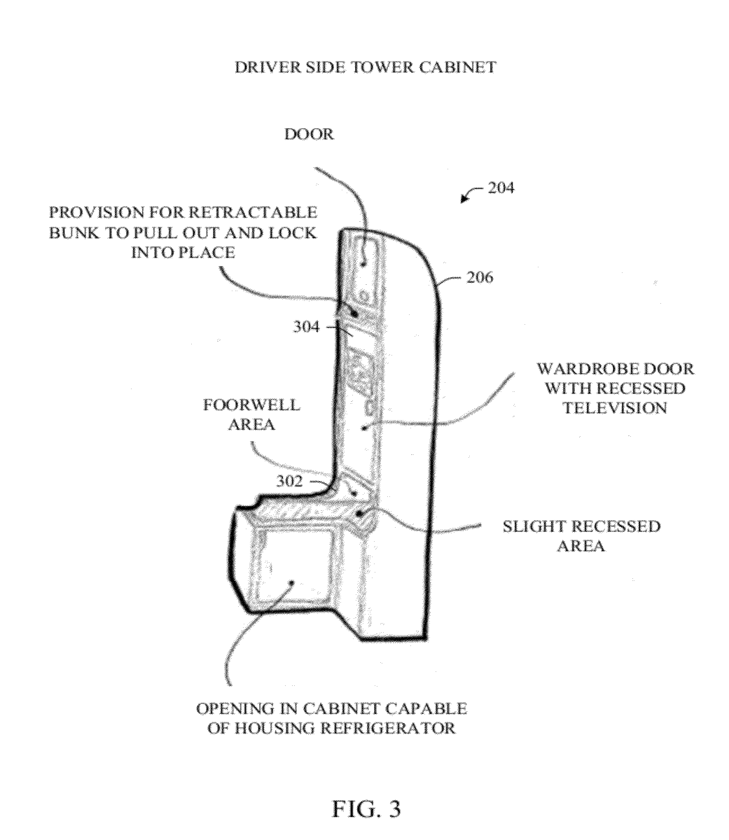

FIG. 3 illustrates an example complementary tower assembly 204 as described supra. As stated earlier, the frame portion 206 can be manufactured of most any suitably rigid material (e.g., wood, plastic, composite, alloy, metal, aluminum)—in a single unit or multiple units. It will be appreciated that the complementary tower 204 can house appliances such as refrigerators, televisions, etc. As shown, a foot well area 302 can be a recessed area within the frame 206. Still further, the complimentary tower assembly frame 206 can be equipped to provide latch (stops or supports) assemblies (not shown) for a retractable bunk, fold-down bunk or the like. The latch assemblies can be included within a pull-out, drop-down, etc. area 304 of the assembly 204. Similarly, the recliner seat assembly (100 of FIG. 1) can include a portion that houses latches, stops or supports that accommodate an upper bunk (e.g., retractable bunk, fold-down bunk, drop-down bunk) (not shown).

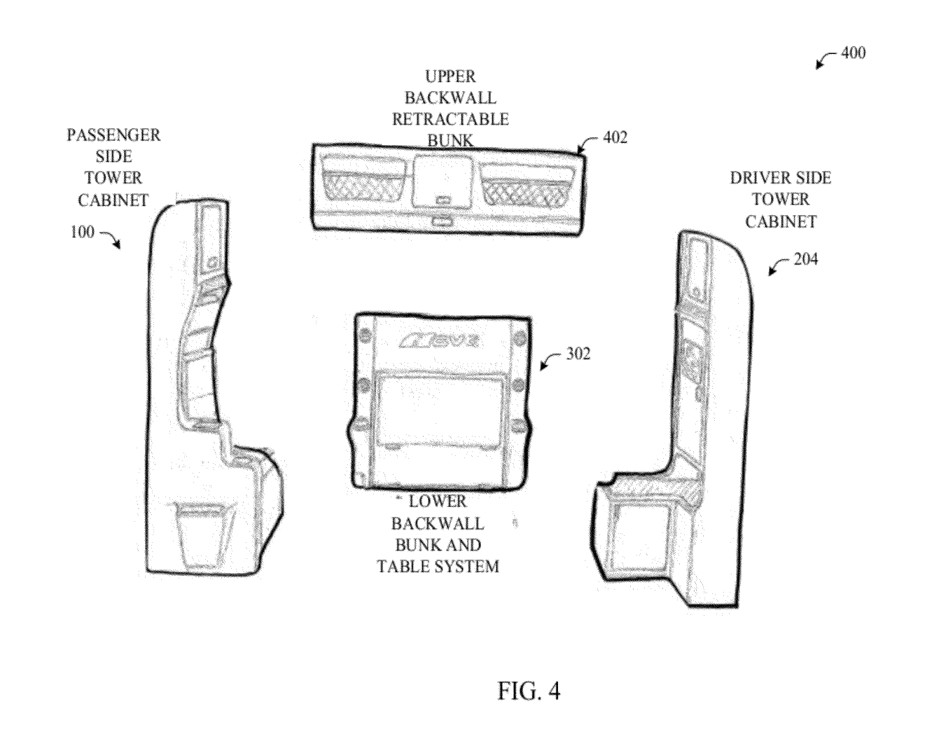

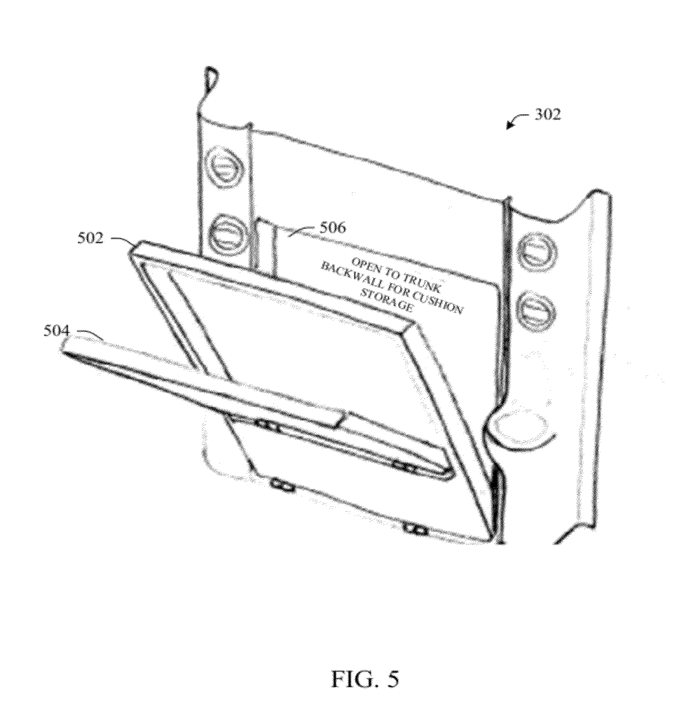

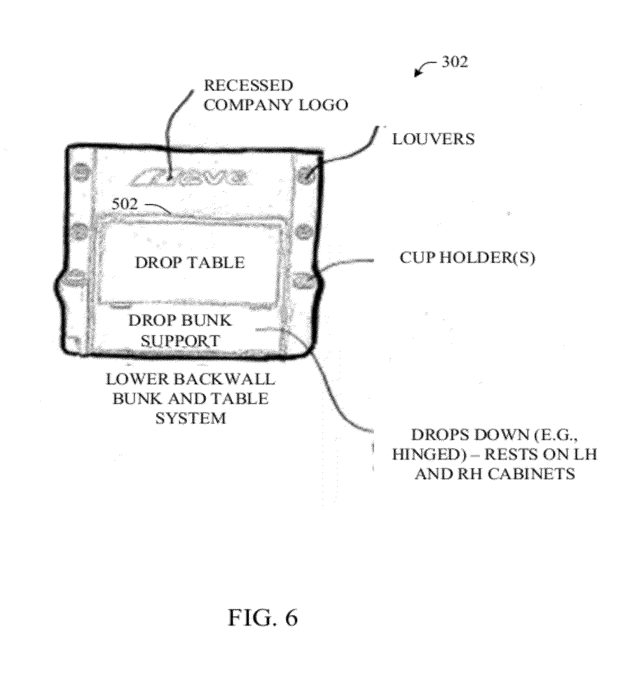

FIG. 4 illustrates an example recliner assembly 400 in accordance with aspects of the innovation. As described supra, the assembly 400 can include a recliner tower seating apparatus 100, a complementary tower apparatus 204 and a drop- or fold-down table assembly 302. The table (or support) assembly 302 will be described in greater detail with regard to FIGS. 5 and 6 that follow.

Additionally, as shown in FIG. 4, the assembly 400 can include an overhead or upper console 402 that houses an upper bunk assembly (not shown). For example, a retractable upper bunk assembly, pull-out bunk or the like can be housed within the upper console 402. As described above, the latches, supports, etc. for the bunk can be housed or otherwise positioned within (or upon) each of the seating assemblies 100, 204.

FIG. 5 illustrates an example drop- or fold-down table/support assembly 302 in accordance with aspects. As stated earlier, the assembly 302 fills the void between the tower apparatuses 100, 204. In operation, the “table” or support portion 502 can be folded down and locked into a horizontal (or near horizontal) position. In the example of FIG. 5, a vertical support 504 or “leg” can be included that essentially folds down (or pivots) and supports the table portion 502 in its horizontal position. Additionally, an optional cushion can be stored in storage area 506 and positioned atop the table portion 502 when deployed.

As will be understood, the horizontal table portion 502 fills the void between the two tower apparatuses 100, 204. The optional cushion can be provided so as to increase comfort of a user's extended legs or body mid-portion. Alternatively, the table portion 502 can be integrally provided with a cushioned top or face portion to enhance comfort and/or appearance. In the aspect of FIG. 5, it will be appreciated that, upon folding down, the table 502 and leg 504 form a “T” shape thereby enhancing support and strength of the table portion 502.

Although not shown, most any latching mechanism can be employed in aspects. The latching mechanism (not shown) can be used to lock/unlock the table portion 502 thereby enabling it to fold down when desired. For example, a latching mechanism similar to that used on an airline tray table can be employed in aspects.

FIG. 6 illustrates yet another aspect of a drop-down bunk or recliner support 302 in accordance with aspects. While specific sizes and shapes are shown, other aspects can employ variations without departing from the features, functions and benefits of the innovation described herein. These alternatives are to be included within the scope of this disclosure.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A recliner tower apparatus, comprising:
a seat assembly having a rear portion that pivots to recline a backrest;
a drop-down table/support positioned adjacent to the seat assembly; and
a complementary seat/footrest apparatus disposed on an opposite side of the drop-down table/support from the seat assembly, wherein the drop-down table/support forms a horizontal plane from the seat apparatus to the complementary seat/footrest apparatus.

2. The system of claim 1, further comprising a tower frame having formed steps that facilitate reach to an elevated item, wherein the seat assembly is positioned within the tower frame.

3. The system of claim 1, further comprising a plurality of mechanisms that support a retractable bunk assembly, wherein a subset of the plurality of mechanisms are positioned within the tower frame.

4. The system of claim 1, further comprising a motorized control that automatically positions the seat assembly as desired.

5. The system of claim 4, further comprising a memory that retains a plurality of seating positions.

6. The system of claim 1, further comprising at least one of an air conditioned cushion, a heated cushion or a sensory enhanced cushion positioned within the seat assembly.

7. The system of claim 1, further comprising a stowable cushion sizably configured to fit atop the drop-down table/support.

8. The system of claim 1, further comprising an integral cushion built into a top surface of the drop-down table/support.

9. The system of claim 1, further comprising hinging means that enable the drop-down table/support to pivot from a substantially vertical to a substantially horizontal position.

10. The system of claim 1, further comprising a pivotable footrest portion that pivots from a substantially vertical to a substantially horizontal position.

11. The system of claim 1, further comprising a complementary recliner tower apparatus configured to house the complementary seat/footrest apparatus, a television and a refrigerator, wherein the drop-down table/support fills a space void between the recliner tower apparatus and the complementary tower apparatus.

12. The system of claim 1, further comprising a hingable vertical support that supports the drop-down table/support in a substantially horizontal position.

13. A seating apparatus, comprising:
a first tower assembly comprising a seat assembly having a rear portion that pivots to recline;
a second tower assembly comprising a complementary seat/footrest apparatus disposed adjacent and away from the first tower assembly; and
a drop-down support positioned between the first tower assembly and the second tower assembly, wherein the drop-down table/support forms a horizontal plane from the seat apparatus to the complementary seat/footrest apparatus.

14. The seating apparatus of claim 13, further comprising a stowable cushion configured to fit atop the drop-down support in a substantially horizontal position.

15. The seating apparatus of claim 13, further comprising a computerized memory that retains at least one position adjustment setting of the seat assembly.

16. The seating apparatus of claim 13, further comprising a pivotable leg that supports the drop-down support in the substantially horizontal position.

17. The seating apparatus of claim 13, wherein the drop-down support includes an integral cushion on an upper surface.

18. The seating apparatus of claim 13, further comprising at least one of an air conditioned cushion, a heated cushion or a sensory enhanced cushion positioned within the seat assembly.

19. The seating apparatus of claim 13, wherein the first tower assembly and the second tower assembly are manufactured of a composite material.

20. The seating apparatus of claim 13, wherein the second tower assembly includes an appliance cavity configured for a refrigerator and a wardrobe cavity having provision for a television.
